(19) United States
(12) Patent Application Publication
(10) Pub. No.: US 2018/0063238 A1
(43) Pub. Date: Mar. 1, 2018

(54) Massively Scalable, Low Latency, High Concurrency and High Throughput Decentralized Consensus Algorithm

(71) Applicant: Jiangang Zhang, San Jose (CA)

(72) Inventor: Jiangang Zhang, San Jose (CA)

(21) Appl. No.: 15/669,612

(22) Filed: Aug. 4, 2017

Related U.S. Application Data
(60) Provisional application No. 62/379,468, filed on Aug. 25, 2016.

(51) Int. Cl. H04L 29/08; G06F 11/14

(52) U.S. Cl. CPC H04L 67/1051; G06F 11/1425

(57) ABSTRACT

A distributed/decentralized consensus algorithm that is auto-adaptive, massively scalable with low latency, high concurrency and high throughput, achieved via parallel processing and location-aware formation of topology and O(n) messages on consensus agreement.

### CROSS REFERENCE TO RELATED APPLICATION

This application claims priority from U.S. Patent Application No. 62/379,468, filed Aug. 25, 2016 and entitled “Massively Scalable, Low Latency, High Concurrency and High Throughput Decentralized Consensus Algorithm” the disclosure of which is hereby incorporated entirely herein by reference.

### FIELD OF THE INVENTION

The present invention is in the technical field of decentralized and/or distributed consensus between participating entities. More particularly, the present invention is in the technical field of distributed or decentralized consensus amongst software applications and/or devices or people and institutions represented by these applications and devices.

### BACKGROUND OF THE INVENTION

Conventional consensus algorithms, are either optimized for large scale, or low latency, or high concurrency, or a combination of some of them, but not all of them. It is difficult to utilize those consensus algorithms in use cases that require massive scale, low latency, and high concurrency and high throughput.

### SUMMARY OF THE INVENTION

The present invention is a decentralized/distributed consensus algorithm that is massively scalable with a low latency, high concurrency and high throughput.

The present invention achieves this by a combination of technics. First, it divides the consensus participating entities (also known as nodes, with a total size denoted as n hereafter)into many much smaller consensus domains based on auto-learned and auto-adjusted location proximity and subject to a configurable optimal upper bound in membership size (denoted as s).

Then, auto-elected auto-adjusted representative nodes(denoted as command node) from each consensus domain forms the command domain, and as the bridge between the command domain and its home consensus domain. Command nodes in the command domain elects and auto-adjust its master (denoted as master node). Master election can be location-biased so that it has the lowest overall low latency to other command nodes. The command domain and all consensus domains forms the so called Consensus Topology in the present invention. There may be multiple layers of consensus domains and command domains but this present invention describes only the “one command domain, multiple flat consensus domain” paradigm for brevity.

The command domain is responsible to accept consensus requests from logically external clients, coordinates with all consensus domains to achieve consensus and return the result to the calling client. All command nodes can accept client requests simultaneously for high throughput and high concurrency, when they are doing it they are called accepting node. A master node is itself a command node and hence can be accepting node, besides issuing signed a sequence number to a request received by an accepting node.

On receiving a REQUEST message from a client, an accepting node contacts the master node to get a sequence number assigned for the request. The it composes a PREPARE message and multicasts it in parallel to all other command nodes. The PREPARE message is signed by the accepting node and includes the original REQUEST, timestamp, current master node, current Topology ID, and sequence number assigned and signed by the master node etc.

Command nodes of a consensus domain, coordinate via same-domain command node coordination mechanism, to forward the PREPARE message to all other nodes in the consensus domain. A “stream” or “batch” of PREPARE messages can be sent.

Upon receiving the PREPARE message, each node in the consensus domain, dry runs the request, returns a DRYRUN message to the command node. The DRYRUN message is signed by each originating consensus node and is composed of the cryptographic hash of current committed state in consensus as well as expected state if/when dry-run effect is committed etc. Depending on the usage of the present invention, if it's used at framework level e.g. in blockchain, DRYRUN can (and should) be super lightweight that it just asserts that the request is received/stored deterministically upon all previous requests or checkpoints. And it does not have to be the final one if a series of deterministic execution is to be triggered.

The command node of each domain for a specific PREPARE message, aggregates all DRYRUN messages (including the one by itself) and multicasts them in one batch to all other command nodes in the command domain.

Each command node, observes in parallel and in non-blocking mode, until two-thirds of all consensus nodes in the topology to agree on a state or one-third+1 of fails to consent. When that happens, it sends a commit-global (if at least two-thirds with consensus) or fail-global (if one-third+1 not in consensus) to all other nodes of its local consensus domain. The accepting node at the same time sends back the result to the client.

Because of parallelism, the present invention, if with a consensus topology of one command domain and many flat consensus domains, requires 6 inter-node hops to complete a request and reach consensus (or not). Due to the location-proximity optimization, 2 of them are within a consensus domain and hence with very low latency (around or less than 20 milliseconds each), and 4 of them are cross consensus domain where the latency largely depends on the geographic distribution of the overall topology (about 100 milliseconds each if cross the ocean, or about 50 milliseconds each if cross a continent or large country). The overall latency could be about 450 milliseconds if deployed globally, or about 250 milliseconds if deployed cross a continent or large country.

Because of parallelism, super simple functionality of the master, balancing of load on all command nodes, O(n) messaging on consensus agreement, the present invention supports massive scalability with high concurrency and high throughput almost linearly. The only serialized operation is the request sequencing by the master, which we can easily achieve 100,000+ operations per second due to the super lightweight nature of the operation.

The present invention support caching of consensus events if nodes or domains are temporally unreachable, which makes it very resilient and suitable for cross-continent and cross-ocean deployment.

### BRIEF DESCRIPTION OF THE DRAWING

FIG. 1 is the two-layer consensus topology with the command domain on top (block 101) and the consensus domains (two shown: block 100-x and 100-y) below.

FIG. 2 is the sequence diagram illustrating the inner working of the consensus algorithm

### DETAILED DESCRIPTION OF THE INVENTION

Client & Application

Consensus Request: A request for retrieval or update of the consensus state. A request can be on read or write type, and mark dependency on other requests, or any entities. This way failure of one request in the pipeline does not fail all following it.

Consensus Client: A logically external device and/or software that sends requests to the consensus topology to read or update the state of the consensus application atop the consensus topology. It's also called client in this invention for brevity.

Consensus Application: a device and/or software logically atop the consensus algorithm stack that has multiple runtime instances each starting from the same initial state and receiving same set of requests from the consensus stack afterwards for deterministic execution of the requests to reach consensus on state amongst these instances. It's also called application for brevity.

Consensus Domain

Consensus Domain is composed of a group of consensus nodes amongst which consensus applies. A consensus node is a device and/or software that participates in the consensus algorithm to reach consensus of state concerned. A consensus node is denoted as N(x, y) where x is the consensus domain it belongs to and y is its identity in that domain. It's also called node in this invention for brevity.

A consensus node can only belong to one consensus domain. The size of a consensus domain, i.e. the number of nodes in the domain, denoted as s, is pre-configured and runtime reconfigurable if signed by all governing authorities of the topology. There are altogether about [n/s] consensus domains in quantity. The max capacity of a consensus domain is s*120% (factor configurable) to accommodate runtime topology reconstruction.

Within each consensus domain, nodes are connected to each other to form a full mesh (or any other appropriate topology). Auto-detection of node reliability, performance and capacity is periodically performed, and appropriate actions are taken accordingly.

Depending on the required balance of scale and latency, a consensus domain can be a consensus domain of consensus domains organized as a finite fractal, mesh, tree, graph etc.

Command Domain

A command domain is composed of representative nodes (command nodes) from each consensus domain. It accepts request from clients, and coordinates amongst consensus domains to reach overall consensus.

A command node is a consensus node in a consensus domain that represents that domain in the Command Domain. The number of command nodes per consensus domain in the command domain is equivalent to the configurable and runtime adjustable balancing and redundancy factor, rf. Each domain internally elects its representative nodes to the command domain via a process called Command Notes Election.

A command node accepts requests (as accepting node), takes part in master election and potentially becomes master node at some period in time. The command nodes of a consensus domain distribute load on interaction with its home consensus domain.

If elected, a command node can also be the Master Node of the overall topology for an appropriated period of time. The master node takes extra responsibility on issuing sequence number to a request when a request is received by an accepting node.

When accepting and processing requests, a command node is in accepting mode, hence also called accepting node for explanation convenience. Note that if a non-command node accepts a request, it would act as a forwarder to its corresponding command node belonging to its consensus domain.

Consensus Topology

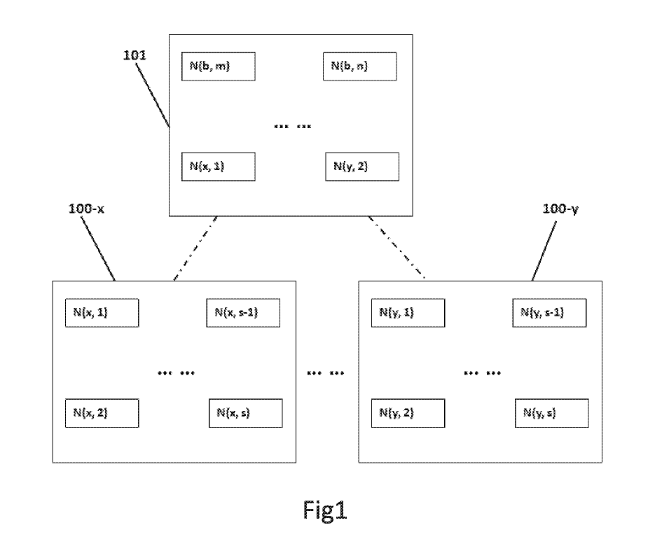

The command domain and all of the consensus domains including all consensus nodes composed of form the consensus topology. Shown in FIG. 1 in the present invention, block 100-x and 100-y are two consensus domains (potentially many others are omitted) and block 101 is the command domain. Small blocks within the command domain or consensus domains, are consensus nodes, denoted as N(x,y) where x is the identifier of the consensus domain, and y is the identifier of the consensus node. The identifier of a domain is a UUID generated on domain formation. The identifier of a consensus node is the cryptographic hash of the node's public key.

The consensus topology is identified by Topology ID, which is a 64-bit integer starting with 1 on first topology formation. It increments by 1 whenever there's a master transition.

Note that this consensus topology can be further turned to a multi-tier command domain and multi-tier consensus domain model for essentially unlimited scalability.

Initial Node Startup

On startup, each consensus node, reads a full or partial list of its peer nodes and the topology from local or remote configuration, detects its proximity to them, joins the nearest consensus domain, or creates a new one if there's none available. It populates the JOINTOPO message to the topology as it would a state change for consensus agreement. The JOINTOPO message has its IP address, listening port number, entry point protocol, public key, cryptographic signatures of its public key from topology governing authorities, timestamp, sequence number, all signed by its private key. Assuming its validity, the topology will be updated as part of the consensus agreement process.

Periodic Housekeeping

Periodically, a consensus node will populate a self-signed HEARTBEAT message to the topology in the local domain and to neighboring domains via its command nodes. The self-signed HEARTBEAT message has its IP address, cryptographic hash of its public key, timestamp, Topology ID, domains it belongs, list of connected domains, system resources, and latency in milliseconds with neighboring directly connected nodes, hash of its current committed state and hash of each (or some) state expected to commit, etc. The topology updates its status about that node accordingly. Directly connected nodes will return a HEARTBEAT message so that it can measure latency and be assured of connectivity. Actions are taken to react to the receipt or missing of HEARTBEAT messages, for example master election, command nodes election, checkpoint commit etc.

Periodically, master(s) of the command domain, reports its membership status via TOPOSTATUS message to the topology in the local domain and to other consensus domains via its command nodes. The TOPOSTATUS message includes its IP address, listening port number and entry point protocol, its public key, the topology (the current ordered list of command nodes, domains and node list, public key hash and status of each node), next sequence number, all signed by its private key. On receiving this message, if a consensus node finds error about itself, it would multicast a NODESTATUS message to the topology in the local consensus domain and to neighboring domains via its command nodes. The NODESTATUS message is composed of what's in the JOINTOPO message with one flag set as “correction”. Command nodes observes NODESTATUS messages, if two-thirds+1 of all nodes challenges its view of the topology with high severity, the current master will be automatically terminated of mastership via the master election process.

Periodically, via observing HEARTBEAT and other messages, master node kicks out nodes that are unreachable or fail to meet the delay threshold set forth by the topology. This is reflected in the TOPOSTATUS message above and can be challenged via NODESTATUS message by the nodes kicked out via the normal consensus agreement process.

Topology Formation

Consensus domains are automatically formed based on location-proximity and adjusted as new nodes join or leave that significant changes reliability, performance, the geographical distribution hence the relative latency of amongst nodes etc.

Regardless of the location, initially all nodes, if total number is less than s, belongs to one consensus domain and up to rf nodes (minimum 1 but no more than 1/10) in the domain are selected as command nodes and form the command domain and one master node is elected. The selection of these command nodes is based on auto-detection of node capacity, performance, throughput and relative latency amongst the nodes etc. The ones most reliable, with the highest power and lowest relative latency are chosen automatically. The list is consensus domain local and part of the consensus domain's state.

Visualize all of the nodes on the map, when at the total number of node is at 1.2*s (round to integer of course), and a new node joins, the original consensus domain is divided into two based on location proximity. This process goes on as topologies expands. This prevents super small consensus domains.

When existing nodes are kicked out, unreachable or voluntarily leave, if it causes the size of the consensus domain is below s/2 and neighboring domain(s) can take what's left, topology change will be auto-trigged such that the nodes in the domain will be moved to neighboring domains and eliminate this one from the topology.

Except the initial formation, topology reconstruction is auto triggered by the master node with consensus from at least two-thirds of all command nodes.

Command Nodes Election

Command nodes election is done within all consensus nodes in a consensus domain. Consensus nodes forms a list ordered by its reliability (number of missed heartbeats per day rounded to the nearest hundreds), available CPU capacity (rounded to the nearest digit), RAM capacity (rounded to the nearest GB), throughput, combined latency to all other nodes, and cryptographic hash of its public key. Other ordering criteria may be employed.

Role of command node is assumed starting from the first consensus node in the list with the first bf (balancing factor) nodes auto-selected. Command node replacement happens if and only if a current command node is unreachable (detected by some consecutive missing HEARTBEAT messages) or is at a faulty state (in HEARTBEAT message). Other transition criteria may be employed.

Each consensus node monitors HEARTBEAT message of all other consensus nodes in the consensus domain, if based on the transition criteria there should be a command node replacement, a command node waits for distance*hbthreshold*interval milliseconds to multicast a CMDNODE_CLAIM message to every other node in the consensus domain. Here distance is the distance that the current node is away from the current command node to be replaced, hbthreshold is pre-configured as the number of missing HEARTBEAT messages that should trigger a command node replacement, interval is how often a consensus node multicast a HEARTBEAT message. The self-signed CMDNODE_CLAIM message includes the Topology ID, its sequence in the command node list, timestamp, public key of the node etc.

On receiving CMDNODE_CLAIM message, a consensus node verifies the replacement criteria and if it agrees with it, it would multicast a self-signed CMDNODE_ENDORSE message, which includes the Topology ID, cryptographic hash of the public key of the command node and timestamp). The consensus node with two-thirds of endorsement from all other consensus nodes in the domain, is a new command node, which will multicast a CMDNODE_HELLO message to all other command nodes and all other consensus nodes in the domain. The self-signed CMDNODE_HELLO message includes the Topology ID, timestamp, cryptographic hash of the list of CMDNODE_ENDORSE messages ordered by the node position in the consensus node list in the domain. A consensus node can always challenge this by multicasting its CMDNODE_CLAIM message to gather endorsements.

Master Node Election

Master node election is done within all command nodes in the command domain. Command nodes forms a list ordered by its reliability (number of missed heartbeats per day rounded to the nearest hundreds), available CPU capacity (rounded to the nearest digit), RAM capacity (rounded to the nearest GB),throughput, combined latency to all other nodes, and cryptographic hash of its public key. Note that other ordering criteria may be employed.

Mastership is assumed one after another in the list starting from the first command node in the list. If end of the list is reached, it starts from the first again. Mastership transition happens if and only if the current master is unreachable (detected by 3 consecutive missing HEARTBEAT messages) or is at a faulty state (in HEARTBEAT message) or it decides to give up by sending a self-signed MASTER_QUIT message, or other transition criteria. The MASTER_QUIT message, triggers the master election immediately.

Every time there's a master transition, the Topology ID increments by 1.

Each command node monitors HEARTBEAT message of all other command nodes, if based on the transition criteria there should be a master transition, a command node waits for distance*hbthreshold*interval milliseconds to multicast a MASTER_CLAIM message to every other node in the command domain. Here distance is the distance that the current node is away from the current master, hbthreshold is pre-configured the number of missing HEARTBEAT that triggers a master transition, interval is how often a consensus node multicast a HEARTBEAT message. The self-signed MASTER_CLAIM message includes the new Topology ID, timestamp, public key of the node etc.

On receiving MASTER_CLAIM message, a command node verifies the master transition criteria and if it agrees with it, it would multicast a self-signed MASTER_ENDORSE message, which includes the Topology ID, cryptographic hash of the master public key and timestamp).The command node with two-thirds of endorsement from all other command nodes, is the new master, which will multicast a

MASTER_HELLO message to all other command nodes. The self-signed MASTER_HELLO message includes the Topology ID, timestamp, (cryptographic hash of, if to be verified out-of-band) the list of MASTER_ENDORSE messages ordered by the node position in the command node list. A command node can always challenge this by multicasting its MASTER_CLAIM message to gather endorsements.

A command node is responsible for multicasting a MASTER_HELLO to all other consensus nodes in its home consensus domain.

In-Domain Command Node Balancing

Command nodes of a specific consensus domain connects to each other to coordinate and balance the load of commanding its domain. There are up to rf (balancing and redundancy factor) of them per consensus domain and they form a ring to evenly cover the whole space of a cryptographic hash of requests. If a request's cryptographic hash falls into the segment that it is responsible, it would serve as the bridge and perform command node duties. If not, it would hold it until receiving HEARTBEAT message from the command node responsible for it so that it's sure that's taken care of. If the responsible node is deemed unreachable or faulty, the next clockwise command node in the ring would assume the responsibility. The faulty or unreachable command node will be kicked out of the command node list of the consensus automatically, which will trigger command node election in the consensus domain for a replacement.

Consensus Agreement

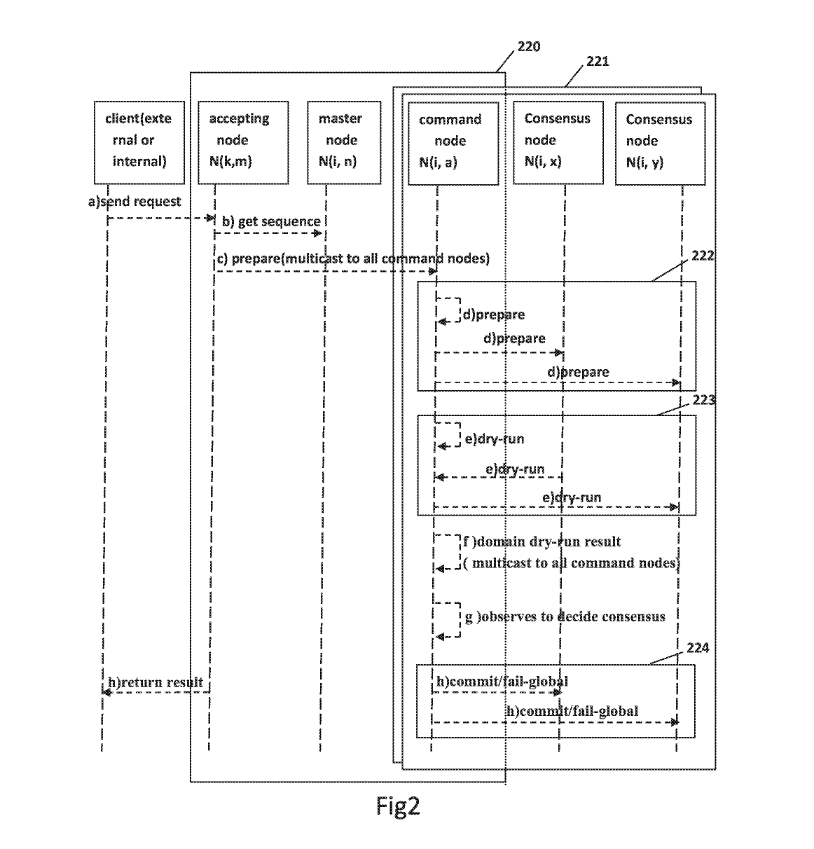

Referring to FIG. 2, here we describe in detail the consensus agreement in the present invention. In FIG. 2, block 220 is the virtual boundary of the command domain, block 221 is the virtual boundary of a consensus domain (there could be many of them).Block 222, 223 and 224 are just virtual grouping of parallel multicasts of the PREPARE, DRYRUN, COMMIT/FAIL messages respectively.

A) A client sends request to one of the command nodes in the command domain. The request can be one of the two type: read (without state change) or write (with state change). On accepting the request, this command node becomes an accepting node.

B) The accepting node, sends a self-signed REQSEQ_REQ message to the master node, which includes cryptographic hash of the request, hash of its public key, timestamp etc. The master node verifies the role of the accepting node and its signature, returns a signed REQSEQ_RES message, which includes current Topology ID, master's timestamp, assigned sequence number, cryptographic hash of the request, hash of its public key, etc.

C) The accepting node multicasts in parallel a self-signed PREPARE message to all command nodes in the command domain, including itself. The PREPARE message is REQSEQ_RES and the request itself.

D) On receiving the PREPARE message, a command node multicast in parallel the PREPARE message to all nodes in the consensus domain, including itself as shown in box 222 of FIG. 2. Each consensus node, writes the PREPARE message into its local persistent journal log.

E) Each consensus node dry-runs in parallel the PREPARE message and returns a self-signed DRYRUN message to the command node of its consensus domain. The DRYRUN message includes expected status (success, fail),cryptographic hash of the last committed state, expected state after committed this state, and expected state for some r all previous requests pending final commit. The state transition is expected to execute the request ordered by <Topology ID, sequence> so that each node is fed with the same set of requests with the same order.

F) After observed at least (two-third+1) consensus state or (one-third+1) faulty from all consensus nodes in its consensus domain including itself, the command node multicasts in parallel these DRYRUN messages in a batch to all other command nodes. Note that remaining DRYRUN messages will be multicast as such when available.

G) Each command node, observes until at least (two-third+1) consensus state or (one-third+1) from all consensus nodes in the whole topology to make the overall commit or fail decision

Once a consensus decision for a request is reached, each command node multicasts in parallel a signed COMMIT or FAIL message to all nodes in its consensus domain including itself. And upon receiving the COMMIT message, which include at least (two-third+1) successful DRYRUN messages, each node commits the expected state. If receiving the FAIL message, the request together with all newer write requests are marked as FAILED(unless the request is independent to the failed one) and returns new DRYRUN messages for newer write requests as FAILED.

The accepting node, in the meanwhile, returns self-signed response message to the calling client. This response message includes, cryptographic hash of the request, status (success or fail), final state, timestamp, etc.

1. A massively scalable, low latency, high concurrency and high throughput decentralized consensus algorithm divides the consensus participating entities into many much smaller consensus domains based on pre-configured or auto-learned and auto-adjusted location proximity and subject to a configurable optimal upper bound in membership size, wherein auto-elected auto-adjusted representative nodes from each consensus domain forms the command domain, and as the bridge between the command domain and its home consensus domain. Command nodes in the command domain elects and auto-adjust its master;
wherein master election can be location-biased so that it has the lowest overall low latency to other command nodes;
wherein the consensus topology is formed by the potentially multi-tier command domains and all potentially multi-tier consensus domains, besides the described one-command domain-and-multiple-flat-consensus-domain paradigm for brevity;
wherein the command domain is responsible to accept consensus requests from logically external clients, coordinates with all consensus domains to achieve consensus and return the result to the calling client;
wherein all command nodes can accept client requests simultaneously for high throughput and high concurrency, when they are doing it they are called accepting node. A master node is itself a command node and hence can be accepting node, besides issuing a signed sequence number to a request received by an accepting node.

2. A massively scalable, low latency, high concurrency and high throughput decentralized consensus algorithm according to claim 1, wherein on receiving a REQUEST message from a client, an accepting node contacts the master node to get a sequence number assigned for the request;
wherein the accepting node composes a PREPARE message and multicasts it in parallel to all other command nodes. The PREPARE message is signed by the accepting node and includes the original REQUEST, timestamp, current master node, current Topology ID, and sequence number assigned and signed by the master node.

3. A massively scalable, low latency, high concurrency and high throughput decentralized consensus algorithm according to claim 1, wherein command nodes of a consensus domain coordinate via same-domain node coordination mechanism, to forward the PREPARE message to all other nodes in the consensus domain. A “stream” or “batch” of PREPARE messages can be sent.

4. A massively scalable, low latency, high concurrency and high throughput decentralized consensus algorithm according to claim 1, wherein upon receiving the PREPARE message, each node in the consensus domain, dry runs the request, returns a DRYRUN message to the command node. The DRYRUN message is signed by each originating consensus node and is composed of the cryptographic hash of current committed state in consensus as well as expected state when dry-run effect is committed.

5. A massively scalable, low latency, high concurrency and high throughput decentralized consensus algorithm according to claim 1, wherein the command node of each consensus domain for a specific PREPARE message aggregates all DRYRUN messages (including the one by itself) and multicasts them in one batch to all other command nodes in the command domain(s).

6. A massively scalable, low latency, high concurrency and high throughput decentralized consensus algorithm according to claim 1, wherein each command node, observes in parallel and in non-blocking mode, until two-thirds of all consensus nodes in the topology to agree on a state or one-third+1 of fails to consent. When that happens, it sends a commit-global (if at least two-thirds with consensus) or fail-global (if one-third+1 not in consensus) to all other nodes of its local consensus domain. The accepting node at the same time sends back the result to the client.

7. A massively scalable, low latency, high concurrency and high throughput decentralized consensus algorithm according to claim 1, wherein requires 6 inter-node hops to complete a request and reach consensus (or not) if with a consensus topology of one command domain and multiple flat consensus domains; 2 of them are within a consensus domain and 4 of them are cross consensus domains.
